(19) United States
(12) Patent Application Publication
(10) Pub. No.: US 2026/0351051 A1
(43) Pub. Date: Nov. 5, 2026

(54) INTEGRATED AUTHORSHIP VERIFICATION SYSTEM VIA STYLOMETRY, BIOMETRICS, DICTATION INPUT, AND OCR HANDWRITING ANALYSIS

(71) Applicant: Alvin Williams, JR., Philadelphia, PA (US)

(72) Inventor: Alvin Williams, JR., Philadelphia, PA (US)

(21) Appl. No.: 19/198,093

(22) Filed: May 4, 2025

(51) Int. Cl. G06V 40/30; G06V 10/75; G06V 30/14; G06V 30/19; G06V 30/32; G06V 30/41; G06V 40/70

(52) U.S. Cl. CPC G06V 40/394; G06V 10/751; G06V 30/14; G06V 30/19013; G06V 30/387; G06V 30/41; G06V 40/70

(57) ABSTRACT

A system and method for verifying the authorship of documents using an integrated combination of stylometric analysis, biometric typing patterns, voice transcription, and OCR handwriting recognition. The system enables document origin verification for typed, handwritten, or dictated input by comparing submissions to a baseline profile, and returns a confidence score. It is designed for use in educational, governmental, and enterprise settings, with bulk-upload and third-party integration capability.

### CROSS-REFERENCE TO RELATED APPLICATIONS

None.

### STATEMENT REGARDING FEDERALLY SPONSORED RESEARCH OR DEVELOPMENT

Not Applicable.

### FIELD OF THE INVENTION

The present invention relates to a comprehensive system and method for verifying the authorship of documents using a multi-modal integration of stylometric analysis, biometric keystroke dynamics, speech-to-text transcription with voice verification, and optical character recognition (OCR) enhanced with handwriting biometrics. The invention is designed for environments requiring high-trust authorship verification such as educational systems, certification platforms, governmental institutions, and enterprise workflows.

### BACKGROUND OF THE INVENTION

With the rise of AI-generated content, ghostwriting, and unauthorized document impersonation, there is a growing global demand for reliable, scalable systems to verify the true authorship of written content. Existing technologies offer fragmented solutions—focusing either on stylometry, biometric input, or voice analysis—but fail to provide an integrated framework capable of handling typed, dictated, and handwritten inputs within one platform.

### SUMMARY OF THE INVENTION

The invention provides a unified authorship verification infrastructure combining the following core components:
A stylometric fingerprint engine that analyzes sentence structure, word choice patterns, paragraph cadence, and document flow.
A biometric input layer capturing keystroke dynamics such as dwell time, flight time, and typing rhythm.
A transcription module for voice-to-text conversion with optional speaker voice biometrics.
An OCR pipeline to digitize scanned or handwritten content.
A handwriting biometrics analyzer that detects pressure, pen angle, stroke curvature, and writing slant from scanned submissions.
A scoring engine that integrates multi-modal data to generate a unified authorship confidence score.
A student baseline management system, which captures supervised writing samples and stores stylometric and biometric profiles.
A teacher dashboard that allows bulk upload of assignments, automatic matching of submissions to known profiles, override and re-verification tools, and review options with audit logs.
An API-ready backend for LMS and document system integrations (e.g., Canvas, Google Docs, Microsoft Teams).

### DETAILED DESCRIPTION OF THE INVENTION

The True Write system may be implemented as a cloud-based application accessible by teachers and institutions. Each user account is linked to a secure baseline writing profile containing stylometric, biometric, and/or voice data. When a teacher uploads multiple documents, the system performs a multi-modal comparison and returns a confidence score for authorship. The use cases originally outlined are provided here as illustrative examples:
Student assignment verification in AI-permissive classrooms.
High-stakes certification exam integrity.
Government document attribution and intelligence operations.
Corporate compliance for sensitive reporting or ghostwriting detection.
Institutional authorship infrastructure to support global educational systems.

1. A system for verifying document authorship comprising: a multi-modal authorship scoring engine configured to ingest two or more behavioral authorship signals, including but not limited to: stylometric analysis, keystroke dynamics, transcription input, handwriting input, biometric metadata, or any behavioral signal derived from digital or physical input channels, and further comprising:
(a) a baseline profiling module,
(b) a confidence scoring engine, and
(c) an interface for document review and result presentation.

2. The system of claim 1, wherein said stylometric analysis module extracts and evaluates lexical richness, n-gram distributions, sentence cadence, and function word frequencies.

3. The system of claim 1, wherein said biometric engine includes dwell time and flight time measures for keystroke pattern analysis.

4. The system of claim 1, wherein said OCR processor is coupled to the handwriting biometrics module to extract stroke pressure, directionality, and curvature.

5. The system of claim 1, wherein the transcription engine incorporates speaker identification features to authenticate the voice source.

6. The system of claim 1, further comprising a comparison engine for evaluating a target submission against one or more baseline profiles.

7. The system of claim 6, wherein the comparison engine produces a percentage-based confidence score and highlights mismatched patterns.

8. The system of claim 1, wherein the baseline profiling system captures inputs under supervision to prevent initial fraud.

9. The system of claim 1, wherein the user interface supports manual override selection of student identity by authorized personnel.

10. The system of claim 1, further comprising an integration module for syncing with third-party platforms and learning management systems.

11. A method for verifying authorship comprising the steps of: (a) collecting baseline writing and biometric data from a verified user; (b) processing a submitted document using stylometric and biometric engines; (c) comparing the submission to baseline profiles; (d) scoring the match with a confidence metric; (e) presenting results via a reviewer dashboard with override and audit capabilities.
